(19) United States
(12) Patent Application Publication
(10) Pub. No.: US 2023/0387710 A1
(43) Pub. Date: Nov. 30, 2023

(54) METHODS AND SYSTEMS FOR CONTROLLING CHARGE AND DISCHARGE CHARACTERISTICS OF LITHIUM-METAL LIQUID-ELECTROLYTE ELECTROCHEMICAL CELLS

(71) Applicant: Cuberg, Inc., San Leandro, CA (US)

(72) Inventors: Jack Fawdon, San Leandro, CA (US); Seamus Bannon, Oakland, CA (US); Nadine Kuhn, Boston, MA (US); Stephen Lawes, San Leandro, CA (US); Ali Hemmatifar, San Leandro, CA (US); Richard Wang, Danville, CA (US); Jeremy Gong, San Leandro, CA (US); Eiara Fajardo, San Leandro, CA (US); Kathryn Hicks, San Leandro, CA (US)

(73) Assignee: Cuberg, Inc., San Leandro, CA (US)

(21) Appl. No.: 18/326,125

(22) Filed: May 31, 2023

Related U.S. Application Data
(60) Provisional application No. 63/365,586, filed on May 31, 2022.

(51) Int. Cl. H02J 7/00; H01M 10/44; H01M 10/6571; H01M 10/615

(52) U.S. Cl. CPC H02J 7/007194; H01M 10/44; H01M 10/6571; H01M 10/615; H02J 7/00711

(57) ABSTRACT

Described herein are methods and systems for controlling the charge and discharge characteristics of lithium-metal liquid-electrolyte (LiMLE) electrochemical cells that ensure extended cycle life even at high charge rates. In some examples, a method comprises charging a LiMLE electrochemical cell using a set of charge characteristics and discharging the cell using a set of discharge characteristics. These characteristics are specifically tailored to the cell design. For example, the cell temperature can be higher during the charge than during the discharge, especially for viscous electrolytes. For example, the cell can be heated before charging, e.g., using a separate heater and/or charge-discharge pulses (before or while charging the cell). In the same or other examples, the set of charge characteristics comprises charge pulses such that each pair of charge pulses is separated by a discharge pulse. The current during each discharge pulse can be greater during each charge pulse.

### CROSS-REFERENCE TO RELATED APPLICATIONS

This application claims the benefit under 35 U.S.C. § 119(e) of U.S. Provisional Patent Application No. 63/365,586, filed on May 31, 2022, which is incorporated herein by reference in its entirety for all purposes.

### BACKGROUND

Lithium-ion (Li-ion or Lil) cells or, more generally, Li-ion batteries are widely used for various applications. For example, Li-ion batteries are used to power devices as small as medical devices or cell phones and as large as electric vehicles or aircraft. The wide adoption of Li-ion batteries across many industries generated many useful designs and knowledge about fabricating Li-ion battery modules and packs. In particular, many concerns involving cycling efficiency, capacity, and safety have been addressed in Li-ion batteries.

Lithium metal (Li-metal or LiM) cells represent a different battery type and are distinct from Li-ion cells. Specifically, Li-ion cells utilize special negative-electrode active materials (e.g., graphite, silicon) to trap lithium ions when the Li-ion cells are charging. On the other hand, Li-metal cells utilize the direct deposition (e.g., plating) of lithium metal on the negative current collectors without a need for any additional active materials for trapping lithium ions. As such, Li-metal cells tend to have a lower weight and a higher energy density in comparison to Li-ion cells. For example, Li-metal has a specific capacity of 3,860 mAh/g, which is about ten times higher than that of graphite.

However, Li-metal cells or, more generally, Li-metal batteries are currently not widely adopted at the scale of Li-ion batteries. Furthermore, Li-metal liquid-electrolyte cells represent a specific category of Li-metal cells in which liquid electrolytes are used to transport lithium ions between positive and negative electrodes. It should be noted that the majority of Li-metal batteries currently used solid electrolytes, which tend provide more control of the lithium metal deposition but has various other drawbacks. For example, the charging rates of Li-metal liquid-electrolyte cells are typically limited due to the specific nature of lithium incorporation on negative electrodes. Specifically, lithium metal is plated directly on the electrode surface (rather than being incorporated into a host material by intercalation or alloying as it occurs in Li-ion cells). Lithium surface-plating can be very sensitive to electrical current rates. For example, high rates can cause uneven lithium-metal deposition because of the uneven distribution of lithium ions within the electrolyte, in particular, highly-viscous electrolytes used in Li-metal liquid-electrolyte cells.

### SUMMARY

Described herein are methods and systems for controlling the charge and discharge characteristics of lithium-metal liquid-electrolyte (LiMLE) electrochemical cells that ensure extended cycle life even at high charge rates. In some examples, a method comprises charging a LiMLE electrochemical cell using a set of charge characteristics and discharging the cell using a set of discharge characteristics. These characteristics are specifically tailored to the cell design. For example, the cell temperature can be higher during the charge than during the discharge, especially for viscous electrolytes. For example, the cell can be heated before charging, e.g., using a separate heater and/or charge-discharge pulses (before or while charging the cell). In the same or other examples, the set of charge characteristics comprises charge pulses such that each pair of charge pulses is separated by a discharge pulse. The current during each discharge pulse can be greater during each charge pulse.

These and other embodiments are described further below with reference to the figures.

### BRIEF DESCRIPTION OF THE DRAWINGS

FIG. 1A illustrates relative-charge-capacity plots of two LiMLE electrochemical cells at the same discharge rate (1 C) but different charge rates (1 C vs. C/2).

FIG. 1B is a block diagram of a LiMLE electrochemical cell, illustrating various components of the cell, in accordance with some examples.

FIG. 1C is a block diagram of a battery pack comprising the LiMLE electrochemical cell in FIG. 1B, illustrating various additional components of the battery pack, in accordance with some examples.

FIG. 2 is a process flowchart corresponding to a method for controlling the charge and discharge characteristics of a LiMLE electrochemical cell, in accordance with some examples.

FIG. 3A is a plot of charge/discharge rates and corresponding cell temperature used for cycling a LiMLE electrochemical cell, in accordance with some examples.

FIG. 3B is a schematic illustration of lithium-ion distribution within the electrolyte while plating lithium on the negative-electrode surface of a LiMLE electrochemical cell, in accordance with some examples.

FIG. 3C are schematic plots of the electrolyte viscosity and lithium-ion mobility as a function of temperature.

FIG. 3D are schematic illustrations of lithium metal distribution on the negative-electrode surface during the same-temperature cycling of a LiMLE electrochemical cell, in accordance with some examples.

FIG. 3E are schematic illustrations of lithium metal distribution on the negative-electrode surface during the high-temperature charging and low-temperature discharging of a LiMLE electrochemical cell, in accordance with some examples.

FIG. 4A is a plot of charging and discharge pulses while charging a LiMLE electrochemical cell, in accordance with some examples.

FIG. 4B is a schematic plot of the lithium-ion concentration gradient at the negative-electrode surface corresponding to the charging and discharge pulses in FIG. 4A, in accordance with some examples.

FIG. 4C is another plot of charging and discharge pulses, separated by rest periods, while charging a LiMLE electrochemical cell, in accordance with some examples.

FIG. 4D is another plot of charge pulses and rest periods while charging a LiMLE electrochemical cell, in accordance with some examples.

FIG. 5A are relative capacity plots illustrating three different cycling conditions.

FIG. 5B illustrates discharge capacity plots illustrating two different cycling conditions.

FIG. 5C illustrates temperature profiles of cells subjected to different AC excitation profiles.

FIG. 5D illustrates the discharge capacity profiles of two cells cycled at different conditions.

### DETAILED DESCRIPTION

In the following description, numerous specific details are outlined to provide a thorough understanding of the presented concepts. The presented concepts may be practiced without some or all of these specific details. In other instances, well-known process operations have not been described in detail to not unnecessarily obscure the described concepts. While some concepts will be described in conjunction with the specific embodiments, it will be understood that these embodiments are not intended to be limiting.

### Introduction

Most conventional Li-ion cells comprise negative electrodes, which are formed by depositing graphite-containing layers over copper current collectors, and positive electrodes, which are formed by depositing metal oxide-containing layers over aluminum current collectors. Fast charging (i.e., the maximum charge current) in such Li-ion cells is limited by several factors. First, high charge rates typically cause significant Ohmic voltage drops such that the cells prematurely reach their voltage cut-offs, e.g., before reaching 100% state of charge (SOC). Second, mass transport limitations can cause concentration gradients of lithium ions (Li⁺) in the electrolyte, which results in incomplete utilization of the positive and negative electrodes. Specifically, these concentration gradients correspond to lithium-ion deficiencies on rough electrode surfaces or, more specifically, within “valleys” on these surfaces. This concentration gradient and voltage drop (caused by the high charge rates) lead to a decrease in potential at the negative electrode surface. When this potential drops below 0 V vs Li, metallic lithium is plated on the electrode surface (rather than being intercalated into the graphite structures positioned within the electrode). The lithium plating can cause dendrite formation and can eventually result in internal cell shorting. Finally, high cell temperatures are generally not desirable and not needed. An increase in temperature increases the reactivity of conventional Li-ion electrolytes and positive active materials (e.g., metal oxides) causing various side reasons, loss of positive active materials available for cycling, electrolyte gassing, and increased impedance. Furthermore, conventional Li-ion electrolytes tend to have low viscosity (e.g., often less than 10 cP).

To address these challenges in Li-ion cells, fast charging solutions generally focus on reducing the lithium-ion concentration gradients in electrolytes and reducing the negative electrode potentials. One approach is a step charging with the charging current being greater in low SOC regions than in high SOC regions. In other words, the charging current is reduced as the Li-ion cell charges/its SOC increases. This step-charging technique aims to prevent the negative electrode potential from dropping below 0 V vs Li, which is associated with lithium plating. It should be noted that lithium plating is not a concern in Li-metal cells but the actual mode of operation in the Li-metal cells.

Li-metal cells use lithium-metal negative electrodes (rather than intercalation materials such as graphite or alloying materials such as silicon) to store the metal lithium and the corresponding charge (electrical energy). In other words, lithium ions are metallically plated (converted into lithium metal by adding electrons) on the electrode surface in lithium-metal cells. This lithium metal plating on the electrode surface represents the exact condition that needs to be avoided in Li-ion cells. As such, many approaches described above regarding Li-ion cells are simply not applicable or can be even detrimental to Li-metal cells.

A specific type of Li-metal cells includes LiMLE electrochemical cells, in which the ionic exchange between lithium-metal negative electrodes and positive electrodes is provided by liquid electrolytes (as opposed to solid and polymer electrolytes in other types of Li-metal cells). The performance of LiMLE electrochemical cells is dictated by the morphology of this lithium-metal plating/deposit, which is driven primarily by the charge conditions (while the lithium metal is plated on the negative electrode). Specifically, porous deposits can cause an increase in impedance (e.g., by providing an additional surface for solid electrolyte interphase (SEI) formation), while dendritic deposits can result in internal shorts.

It has been found that the major performance factor (influencing the morphology of lithium-metal deposits and, more generally, the cycle life of LiMLE electrochemical cells) is the lithium-ion concentration gradient at the surface of lithium-metal negative electrodes while plating the lithium-metal on this surface (i.e., while charging the LiMLE electrochemical cells). As noted above, lithium-ion concentration gradients (caused by the mass transport limitations) correspond to lithium-ion deficiencies in valley portions of the electrode surface. Various experiments have shown that the timescale of lithium-ion concentration gradient generation is less than 60 seconds or, more specifically, less than 10 seconds or even less than 1 second. The lithium-ion concentration gradient in the electrolyte takes time to form while the ions are consumed at the surface of the negative electrode to form a lithium metal deposit. The time is dependent on two main factors, namely the diffusivity (or viscosity) of the electrolyte and the thickness of the separator. The magnitude of the lithium-ion concentration gradient is dependent on other factors too, including the transference number and current (charge rate). An increase charge rate will increase the magnitude of the concentration gradient. Over time, the concentration gradient increases until a steady state is reached. As such, any extended periods of high-current charging tend to cause the formation of porous lithium-metal deposits.

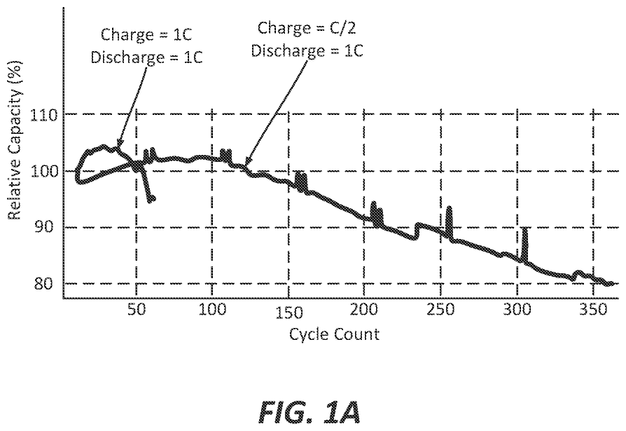

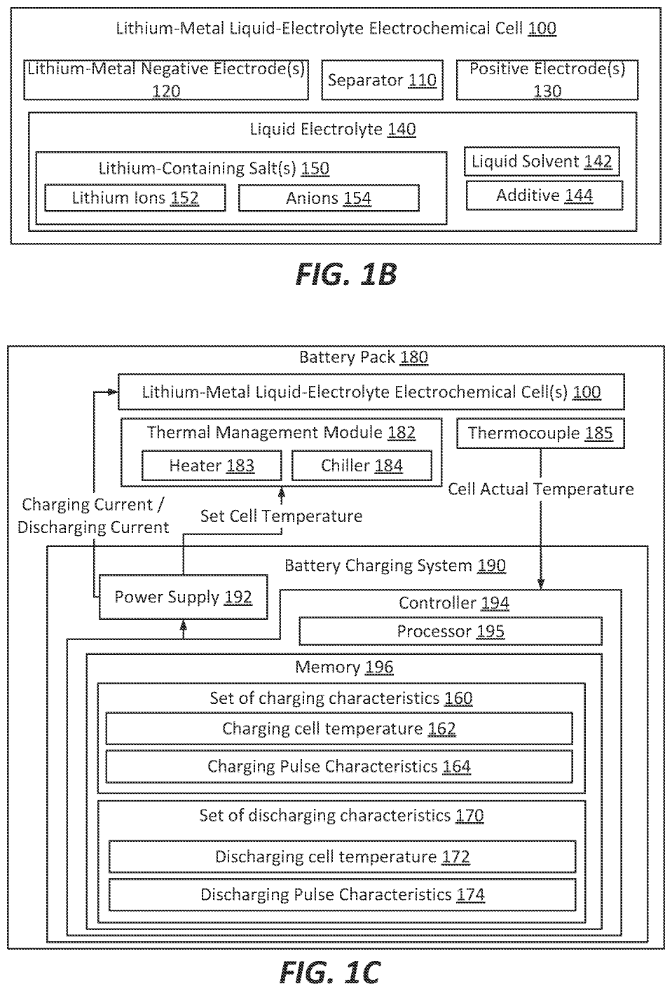

Overall, in Li-metal cells and, more specifically, in LiMLE electrochemical cells, the initial capacity fading (e.g., the cycle life to the 80% capacity retention) is strongly impacted by cells' charge rates. As noted above, the charge rates directly impact the morphology of the lithium metal deposits. For example, FIG. 1A illustrates plots of relative charge capacity obtained during the cycling of two LiMLE electrochemical cells at the same discharge rate of 1 C but different charge rates of 1 C vs. C/2. The cell charged at 1 C experienced a rapid capacity fade after approximately 20 cycles with the test terminated at approximately 60 cycles. The cell charged at C/2 has experienced a much more gradual capacity fade, lasting over 350 cycles. It should be noted that both cells had the same construction. At the same time, fast charge rates are important for many applications, e.g., to increase the utilization of LiMLE electrochemical cells by reducing the time spent on the charger.

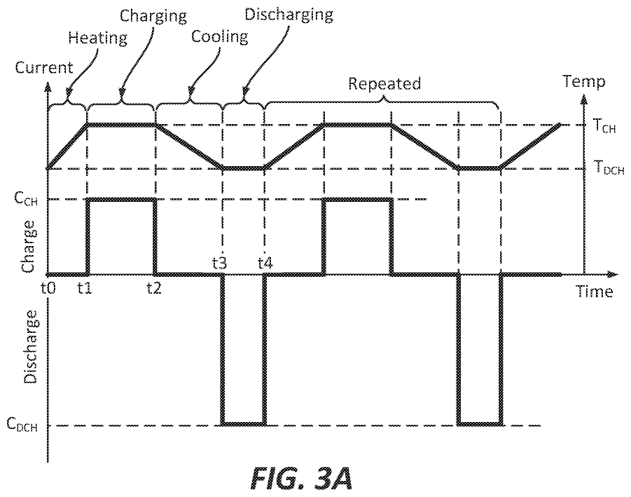

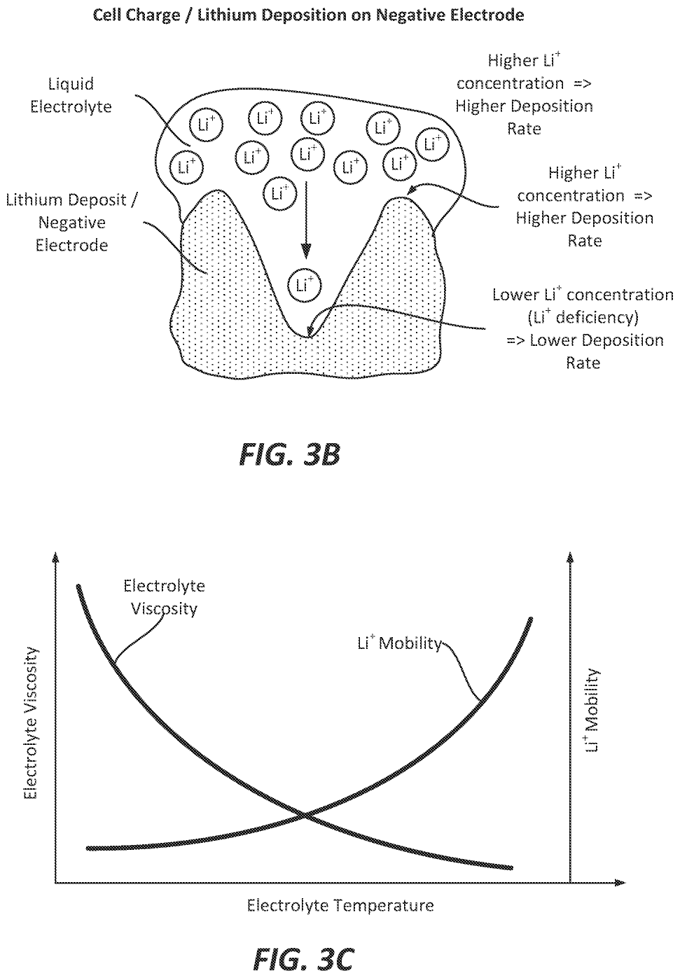

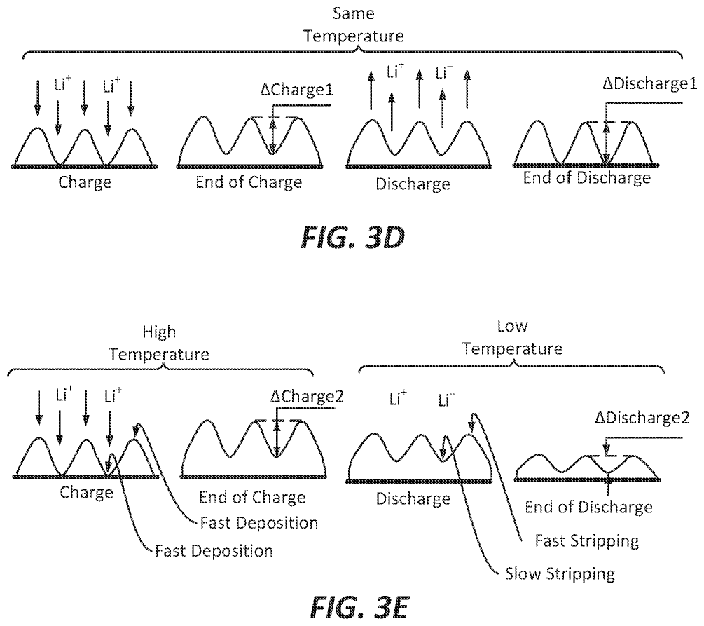

Unfortunately, lithium-ion concentration gradients in liquid electrolytes of LiMLE electrochemical cells are self-aggravating. For example, due to the transport properties of the electrolyte, some concentration gradient appears during the initial charge step of these LiMLE electrochemical cells. Any micro-scale to atomic-scale imperfections, on the negative electrode surface or, more specifically, on the surface of the lithium metal, increase these imperfections effectively forming “peaks” and “valleys” on this surface. Specifically, the concentration gradient makes more lithium ions available for the depositions on the peaks and fewer lithium ions available for the depositions in the valleys as shown and further described below with reference to FIG. 3B. With more lithium ions available at the peaks, these peaks experience faster deposition rates, effectively making these peaks even taller (relative to the valleys) resulting in increased surface roughness. This roughness also increases the tortuosity of the path for lithium ions in subsequent cycles, leading to even greater concentration gradients and an even rougher surface of the lithium-metal negative electrode.

Furthermore, various liquid electrolytes used in LiMLE electrochemical cells tend to have higher viscosities. It should be noted that the liquid electrolyte formulations are particularly challenging in LiMLE electrochemical cells since lithium metal (which is highly reactive) remains in constant contact with the liquid electrolyte. To address these safety concerns, electrolyte formulations tend to have high concentrations of ionic liquids (e.g., lithium bis(fluorosulfonyl)imide (LiFSI), lithium bis(trifluoromethylsulfonyl)amide (LiTFSI)) as further described below. However, these higher viscosity aspects tend to further aggravate the lithium-ion concentration gradient issues described above.

### Examples of LiMLE Electrochemical Cells

FIG. 1B is a block diagram of LiMLE electrochemical cell 100, illustrating various components of the cell and providing some context to various features further described below, in accordance with some examples. LiMLE electrochemical cell 100 comprises lithium-metal negative electrode 120, positive electrode 130, and separator 110, which is positioned between lithium-metal negative electrode 120 and positive electrode 130 and provides electronic isolation between lithium-metal negative electrode 120 and positive electrode 130. One having ordinary skill in the art would understand that LiMLE electrochemical cell 100 can have any number of positive and negative electrodes arranged in different ways, e.g., stacked, wound, and the like. LiMLE electrochemical cell 100 also comprises liquid electrolyte 140, which provides ionic transfer between lithium-metal negative electrode 120 and positive electrode 130. For example, liquid electrolyte 140 soaks separator 110 or, more specifically, the pores of separator 110. Liquid electrolyte 140 should be distinguished from solid and gel electrolytes used in other types of lithium-metal cells. Liquid electrolyte 140 should be distinguished from gel electrolytes, in which polymer matrices retain are used to retain salts and solvents. Liquid electrolyte 140 described herein are free from polymer components such as polyacrylonitrile (PAN), polymethylmethacrylate (PMMA), polyvinylchloride (PVC), and polyvinylidene fluoride (PVDF) and have a viscosity of less than 1,000 cP, less than 500 cP, or less than 200 cP at the room temperature.

Some examples of liquid electrolyte 140 include, but are not limited to, a mixture of one or more lithium-containing salts 150 and one or more liquid solvents 142. Some examples of lithium-containing salts 150 include, but are not limited to, lithium bis(fluorosulfonyl)imide (LiFSI), lithium bis(trifluoromethylsulfonyl)amide (LiTFSI), lithium tetrafluoroborate (LiBF₄), lithium hexafluorophosphate (LiPF₆), lithium bis(oxalato)borate (LiBOB), lithium difluoro(oxalato)borate (LiDFOB), lithium trifluoromethanesulfonate (LiTf), lithium nitrate (LiNO₃), and various combinations thereof. In some examples, lithium-containing salts 150 are LiFSI or LiTFSI, e.g., preferably LiFSI. Lithium-containing salts 150 are configured to dissociate into lithium ions 152 and anions 154. In some examples, the concentration of lithium-containing salts 150 in liquid electrolyte 140 is between 10 mol % and 50 mol % or, more specifically, between 20 mol % and 40 mol %.

Some examples of liquid solvents 142 but are not limited to, one or more cyclic ethers (e.g., 1,3-dioxane (DOL), 1,4-dioxane (DX), tetrahydrofuran (THF)), one or more linear ethers (e.g., dimethoxyethane (DME), Bis(2-methoxyethyl) ether (G2), triethylene glycol dimethyl ether (G3), or tetraethylene glycol dimethyl ether (G4), Bis(2,2,2-trifluoroethyl)ether (BTFE), ethylal, 1,1,2,2-tetrafluoroethyl 2,2,3,3-tetrafluoropropyl ether (TFPE)), and a combination thereof. In some examples, the concentration of liquid solvents 142 in liquid electrolyte 140 is between 0 mol % and 60 mol % or, more specifically, between 5 mol % and 50 mol % or even between 10 mol % and 40 mol %. A specific category of liquid solvents 142 is fluoroether diluents, e.g., bis(2,2,2-trifluoroethyl)ether (BTFE), ethylal, and 1,1,2,2-tetrafluoroethyl 2,2,3,3-tetrafluoropropyl ether (TFPE)), 0-60 mol %. More molecules could be added here.

Liquid electrolyte 140 can comprises various additives 144, e.g., metal salts (e.g., having bis(trifluoromethanesulfonyl)imide (TFSI), bis(fluorosulfonyl)imide (FSI), hexafluorophosphate (PF₆), tetrafluoroborate (BF₄), and/or bis(oxalate)borate (BOB) anions), ionic liquids (e.g., propyl-methyl-pyrrolidinium-FSI/TFSI; butyl-methyl-pyrrolidinium-FSI/TFSI; octyl-methyl-pyrrolidinium-FSI/TFSI, and any combination thereof), and the like.

In some examples, liquid electrolyte 140 comprises ionic liquids in addition to or instead of additives 144. Some examples of ionic liquids include, but are not limited to, 1-allyl-3-methylimidazolium bis(trifluoromethanesulfonyl)imide (AMIm)TFSI and 1-methyl-3-propylimidazolium bis(trifluoromethanesulfonyl)imide (Im₁₃TFSI, or Im₁₃TFSI-SiO₂), n-methyl-n-propylpiperidinium bis(trifluoromethanesulfonyl)imide (Pip₁₃TFSI or Pip₁₃TFSI-SiO₂), n-propyl-n-methylpyrrolidinium bis(fluoromethanesulfonyl)imide (PYR₁₃FSI), n-butyl-n-methylpyrrolidinium bis(fluorosulfonyl) imide (PYR14FSI), tri-methylhexyl ammonium bis-(trifluorosulfonyl) imide (TMHATFSI), butyl-trimethyl ammonium bis(trifluoromethanesulfonyl)imide (QATFSI), 3-(2-(2-methoxy ethoxy)ethyl)-1-methylimidazolium TFSI (IMI_{1,10201}TFSI) and 1-(2-methoxyethyl)-3-methylimidazolium TFSI (IMI_{1,201}TFSI). In some examples, the concentration of the ionic liquids in liquid electrolyte 140 is between 0 mol % and 40 mol % or, more specifically, between 5 mol % and 35 mol %, or even between 10 mol % and 30 mol %.

In some examples, liquid electrolyte 140 can have a viscosity of at least 15 cP or, more specifically, at least 25 cP, at least 50 cP, or even at least 100 cP at room temperature. For example, liquid electrolyte 140 can have a viscosity of 15-500 cP or, more specifically, 20-300 cP or, more specifically, 40-200 cP at room temperature. High viscosity can be driven by specific components needed in liquid electrolyte 140 to enable the functioning of liquid electrolyte 140 in LiMLE electrochemical cell 100. It should be noted that the viscosity changes with temperature. In fact, this characteristic is used to enable the controlled deposition of lithium metal during fast charging (e.g., a charge rate of at least 0.8 C or even at least 1 C). The viscosity determined the ionic diffusivity (lithium ions) within liquid electrolyte 140. In some examples, liquid electrolyte 140 can have an ionic diffusivity of between 1E-13 m²/sec-1E-10 m²/sec or, more specifically, 5E-12 m²/sec-5E-10 m²/sec or, even more specifically, 1E-12 m²/sec-1E-11 m²/sec at room temperature.

Positive electrode 130 can include a current collector (e.g., an aluminum foil) and an active material layer comprising an active material (e.g., in the form of particles) and a binder (e.g., a polymer binder). Some examples of positive active materials include, but are not limited to, lithium nickel manganese cobalt (NMC) oxides, lithium iron phosphate, and the like. Some examples of suitable binders include, but are not limited to, polymer binders (e.g., polyvinylidene-fluoride (PVDF), styrene-butadiene rubber (SBR), and carboxyl methyl cellulose (CMC)). In some examples, positive electrode 130 comprises a conductive additive (e.g., carbon black/paracrystalline carbon). In some examples, positive electrode 130 single-crystal nickel-manganese-cobalt (NMC)-containing structures. The single-crystal NMC-containing structures can have a nickel concentration of at least 70% atomic or even at least 80% atomic. Because the bonds within the primary particles are stronger than between primary particles (in polycrystalline materials), single-crystal NMC particles inherently do not have or show intergranular cracking in a way that polycrystalline NMC particles do. Furthermore, single-crystal NMC particles tend to have higher specific capacities due to the greater surface-area-to-volume ratio of the individual particles vs. secondary-particle agglomerates of polycrystalline NMC materials. However, single-crystal NMC particles tend to have slower lithium transport kinetics than polycrystalline materials. As such, increased temperatures during the charge portion of the cycle help with increasing the rate of lithium ion extraction from single-crystal NMC particles.

In some examples, single-crystal NMC particles are used with liquid electrolyte 140 comprising one or more imide-containing salts, such as bis(trifluoromethanesulfonyl)imide (TFSI⁻)-containing salts, bis(fluorosulfonyl)imide (FSI⁻)-containing salts, and bis(pentafluoroethanesulfonyl)imide (BETI⁻)-containing salts. These salts can also include various cations, such as lithium (Li⁺), potassium (K⁺), sodium (Na⁺), cesium (Cs⁺), n-propyl-n-methylpyrrolidinium (Pyr13⁺), n-octyl-n-methylpyrrolidinium (Pyr18⁺), and 1-methyl-1-pentylpyrrolidinium (Pyr15⁺). For example, imide-containing salts can act as a source of lithium ions in lithium-metal salts. In some examples, the liquid electrolyte further comprises one or more of 2,2,2-Trifluoroethyl Ether (TFEE), 1,1,2,2-Tetrafluoroethyl 2,2,3,3-tetrafluoropropyl ether (TFPE), one or more phosphites, and one or more phosphates.

Lithium-metal negative electrode 120 can also include a current collector on which a lithium metal layer is deposited when LiMLE electrochemical cell 100 is charged. Some examples of suitable current collectors include, but are not limited to, lithium (remaining after the full discharge/ the lowest SOC), copper, nickel, aluminum, stainless steel, a metalized polymer substrate (e.g., metalized with copper), and a carbon-coated metal substrate. Lithium-metal-based electrodes help to improve the gravimetric and volumetric capacities of LiMLE electrochemical cell 100 (in comparison in comparison to lithium-ion cells with graphite-based electrodes). For example, the thickness of the lithium-metal layer (at the lowest SOC) can be less than 40 micrometers, less than 20 micrometers, or even less than 10 micrometers. Furthermore, the addition of a current collector also helps to keep the thickness of the lithium-metal layer small. For example, thicknesses of less than 20 micrometers are difficult to achieve with freestanding lithium. As such, lithium-metal cells with negative electrodes formed by freestanding lithium foils/layers require substantially more lithium than lithium-metal cells with negative electrodes formed by a combination of a current collector and a lithium-metal layer (to achieve the same cell capacity). Lower amounts of lithium are highly desirable from the safety perspective as less lithium ejecta (e.g., molten lithium ejecta) needs to be contained when the cell goes into a thermal runaway. It should be noted that lithium-metal negative electrode 120 forms a solid electrolyte interphase (SEI) layer when exposed to liquid electrolyte 140 at operating potentials. Furthermore, a naturally-forming SEI layer can be supplemented with or partially/fully replaced with an artificial SEI layer (e.g., formed on the surface of lithium-metal negative electrode 120 before contacting liquid electrolyte 140). In either case, an SEI layer (natural and/or artificial) can interfere with the lithium-ion migration in and out of lithium-metal negative electrode 120. Raising the temperature before charging, helps to improve the ionic conductivity of such SEI layers.

Positive electrode 130, lithium-metal negative electrode 120, separator 110, and liquid electrolyte 140 can be referred to as internal components of lithium-metal electrochemical cell 110. These internal components are sensitive to moisture and other ambient conditions and insulated from the environment by a cell enclosure, such as a metal (e.g., aluminum) case (e.g., for cylindrical or prismatic cells), a pouch laminate, an aluminum-coated polymer (e.g., polyamide, polyester, polyurethane, and polypropylene). It should be noted that LiMLE electrochemical cell 100 can be heated internally and/or externally. When internal heating is used, the cell enclosure can be thermally insulated to reduce heat dissipation to the environment. Some examples of such thermally insulating features include, but are not limited to, different intercell structures (e.g., thermal-barrier sheet). In should be noted that such structures can also be used for applying cell pressure and/or preventing heat/material propagation during various thermal events. On the other hand, when external heating is used, the cell enclosure can be thermally conductive to promote heat transfer from an externally positioned heater to the cell interior. Some examples of such thermally conductive features include, but are not limited to, intercell heat-conducting structures (e.g., also used for cell cooling during other operations).

FIG. 1C is a block diagram of battery pack 180 comprising LiMLE electrochemical cell 100 in FIG. 1B, illustrating various additional components of battery pack 180, in accordance with some examples. Battery pack 180 can include any number of LiMLE electrochemical cells 100, e.g., one, two, three, or more. Multiple LiMLE electrochemical cell 100 can be used with various types of in-series and/or parallel connections to boost the voltage and/or current of battery pack 180.

In some examples, battery pack 180 comprises thermocouple 185 to measure the temperature of LiMLE electrochemical cell 100. These temperature measurements can be used to trigger various charge and/or discharge operations as further described below. Furthermore, battery pack 180 can include thermal management module 182 for changing the temperature of LiMLE electrochemical cell 100. Thermal management module 182, when one is present, is thermally coupled to LiMLE electrochemical cell 100. Thermal management module 182 can include one or both heater 183 (e.g., a resistive heater) and chiller 184 (e.g., a liquid-cooled plate). Heater 183 and/or chiller 184 can be positioned externally to LiMLE electrochemical cell 100, e.g., thermally coupled to the enclosure of LiMLE electrochemical cell 100. In some examples, heater 183 can be positioned internally, e.g., one or more resistive elements stacked together with electrodes. Overall, heater 183 can be a module heater, thermally coupled to LiMLE electrochemical cell 100 as well as other cells in the same module. In the same or another example, heater 183 can be an intercell heater, directly interfacing LiMLE electrochemical cell 100. In further examples, heater 183 can be an intracell heater, extending within LiMLE electrochemical cell 100.

Furthermore, heater 183 and/or chiller 184 can be provided at a module level (e.g., heating/cooling the entire module and all LiMLE electrochemical cells within this module at the same time). Alternatively, LiMLE electrochemical cell 100 can be self-heated, e.g., using an AC excitation profile as further described below. In this example, the internal resistance of LiMLE electrochemical cell 100 (provided by the electrodes and electrolyte) is used for heating LiMLE electrochemical cell 100. The cooling of LiMLE electrochemical cell 100 can be provided by the environment.

In some examples, battery pack 180 comprises battery charging system 190 for controlling the charge and discharge characteristics of LiMLE electrochemical cell 100. Battery charging system 190 can comprise power supply 192 configured to flow an electric current through LiMLE electrochemical cell 100 in accordance with the set of charging characteristics while charging LiMLE electrochemical cell 100 and in accordance with the set of discharge characteristics while discharging LiMLE electrochemical cell 100. Various examples of these characteristics are described below.

In some examples, battery charging system 190 comprises controller 194, communicatively coupled to power supply 192 and configured to control the operations of power supply 192, e.g., by providing the set of charging characteristics and the set of discharge characteristics. Controller 194 can also be communicatively coupled to thermocouple 185 and receive the temperature of LiMLE electrochemical cell 100, which is used for various control functions. Controller 194 can also be communicatively coupled to thermal management module 182 to control the operation of thermal management module 182 (e.g., heat or cool LiMLE electrochemical cell 100 to a set cell temperature).

In some examples, controller 194 comprises processor 195 and memory 196, e.g., storing set of charging characteristics 160 and set of discharge characteristics 170. For example, set of charging characteristics 160 comprises charging cell temperature 162, while set of discharge characteristics 170 comprises discharging cell temperature 172 such that charging cell temperature 162 is higher than discharging cell temperature 172. In the same or other examples, set of charging characteristics 160 comprises charge pulse characteristics 164, while set of discharge characteristics 170 comprises discharge pulse characteristics 174. For example, each pair of charge pulses is separated by a discharge pulse. Furthermore, the current rate of the discharge pulse (provided in discharge pulse characteristics 174) can be higher than that of the charge pulses (provided in charge pulse characteristics 164).

In some examples, battery charging system 190 can be connected to multiple battery packs at the same time and be used for the corresponding charging and discharging of these battery packs. In fact, the energy received by battery charging system 190 while discharging one of these battery packs can be used for charging another one of the battery packs. In general, battery charging system 190 can be connected to a grid system for sending and receiving energy needed for charging and discharging battery packs.

### Examples of Controlling Charge and Discharge Characteristics

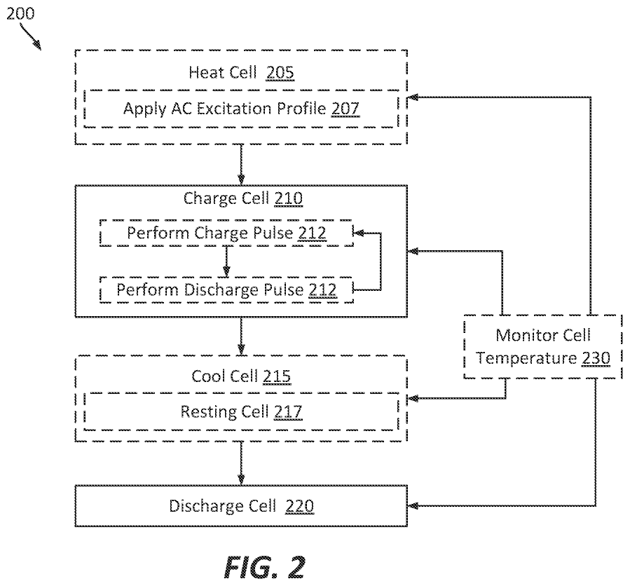

FIG. 2 is a process flowchart corresponding to method 200 for controlling the charge and discharge characteristics of LiMLE electrochemical cell 100, in accordance with some examples. Various examples of LiMLE electrochemical cell 100 are described above. When the power demand for LiMLE electrochemical cell 100 is predictable and corresponds to discharge characteristics 170 of LiMLE electrochemical cell 100, this method can be performed for all or at least some of the operational cycles. Alternatively, this method is performed as a part of periodic/restorative cycling (separate from operational cycling). In general, fast charging and cell heating may result in some cell degradation (even though many other aspects have been mitigated by various features of the described method). Furthermore, cell heating by AC excitation effectively increases the number of charge/discharge cycles experienced by LiMLE electrochemical cell 100, which should be kept to a minimum. As such, selective execution of this method based on various triggers may be used.

Various triggers for switching from operational cycling to restorative cycling are within the scope, e.g., a discharge capacity, an overpotential, an impedance, a direct-current (DC) resistance, the rest period duration, an open circuit voltage, operating discharge and/or charge currents, and an operating cycle count. For example, method 200 may involve collecting various operating parameters such as (1) the discharge capacity of LiMLE electrochemical cell 100 while cycling using operating conditions, (2) the overpotential of LiMLE electrochemical cell 100 while cycling using operating conditions, (3) the impedance of LiMLE electrochemical cell 100; (4) the DCIR of LiMLE electrochemical cell 100; (5) the rest period duration since cycling; (6) the OCV during the rest period since cycling; (7) various previous operating conditions (e.g., operating-discharge current and/or operating-charge current during cycling); and (8) the operating cycle count after the last execution of method 200. Other operating parameter examples are also within the scope. These collected parameters can be analyzed to determine the trigger for method 200.

In some examples, the trigger can be an upcoming demand for a fast charge. For purposes of this disclosure, a charge rate exceeding 0.75 C, 1 C, 1.5 C, or even 2 C can be referred to as a fast charge. As a reference, most LiMLE electrochemical cells are charged at a rate of 0.5 C or less due to various concerns with the cell degradation associated with the fast charge (described above). It should be noted that in electrochemical cells or, more specifically, LiMLE electrochemical cells the baseline for the charge rate (i.e., the “C” reference) represents the capacity of positive electrode 130.

In some examples, method 200 comprises (block 205) heating LiMLE electrochemical cell 100 to the charging cell temperature. For example, the charging cell temperature can be higher than the discharging cell temperature by at least 20° C. or, more specifically, by at least 30+ C. or even by at least 40° C. In the same or other examples, the charging cell temperature is between 45° C. and 90° C. or, more specifically, between 50° C. and 80° C. such as between 60° C. and 70° C. While a high charging cell temperature is desired from the electrolyte viscosity and lithium-ion mobility perspectives (as further described below with reference to FIGS. 3B and 3C), excessive temperatures can cause various side reactions (e.g., gassing, positive active material degradation, electrolyte decomposition/evaporation) and even damage internal cell components, such as a separator.

For example, the charging cell temperature can be selected based on at least one of the oxidative stability of liquid electrolyte 140 and the viscosity of liquid electrolyte 140 or, more specifically, to achieve the desired viscosity of liquid electrolyte 140. The oxidative leakage current changes with temperature based on the Butler-Volmer equation. Specifically, the log of the oxidative leakage current (LN(i)) is dependent on the 1/(Temperature) change. Examples suggest if the 4.4V oxidative leakage current is 5 mA at it was 0.4 mA at 25° C. The viscosity of liquids (in particular, ionic liquids) is highly dependent on temperature, e.g., the Andrade equation (the two-parameter exponential):

$$μ = A {e}^{\frac{B}{T}}$$

For example, the viscosity of many FSI-based and TFSI-based ionic liquids drops from 60-100 cP at 20° C. to less than 20 cP at 60° C.

It should be noted that the heating operation is performed prior to charging LiMLE electrochemical cell 100. In some examples, the heating operation is completed before LiMLE electrochemical cell 100 starts charging. In other words, the charging operation is initiated only after LiMLE electrochemical cell 100 reaches the charging cell temperature. Alternatively, the heating and charging operations at least partially overlap. For example, the charging operation can start while LiMLE electrochemical cell 100 is still being heated (e.g., by an external heater). In some examples, the heating and charging operations fully overlap as described below.

In some examples, (block 205) heating LiMLE electrochemical cell 100 is performed using heater 183 (e.g., an external heater), thermally coupled to LiMLE electrochemical cell 100. Various examples of heater 183 are described above with reference to FIG. 1C. Alternatively, (block 205) heating LiMLE electrochemical cell 100 is performed by (block 207) applying an AC excitation profile to LiMLE electrochemical cell 100. Specifically, the AC excitation profile can be applied by power supply 192 based on instructions from controller 194. Specifically, the AC excitation profile comprises a set of excitation charge pulses and a set of excitation discharge pulses, alternating with the set of excitation charge pulses (e.g., each excitation charge pulse follows by an excitation discharge pulse). This alternating of charge and discharge pulses produces internal heating without degradation of the lithium metal layer and losses of the SOC.

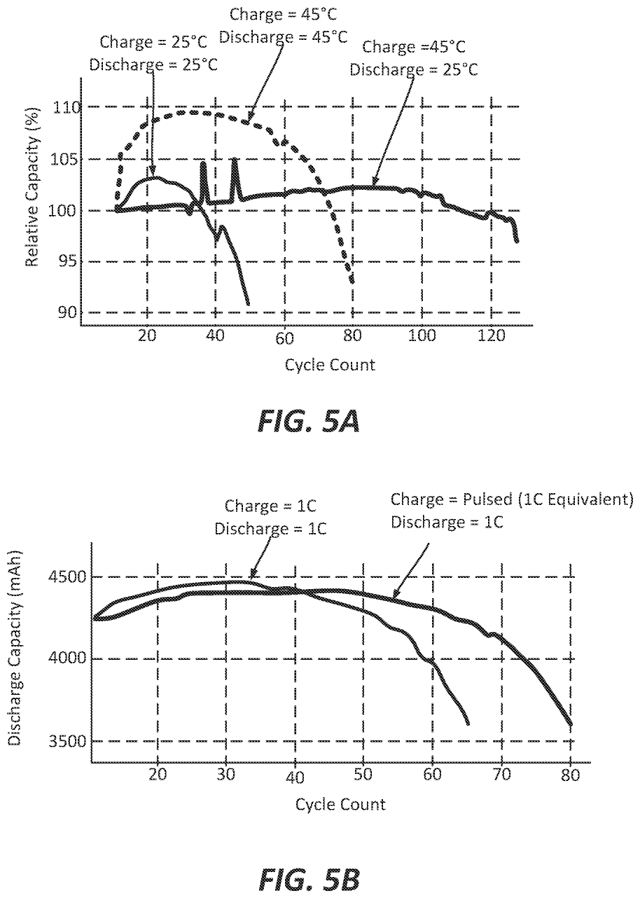

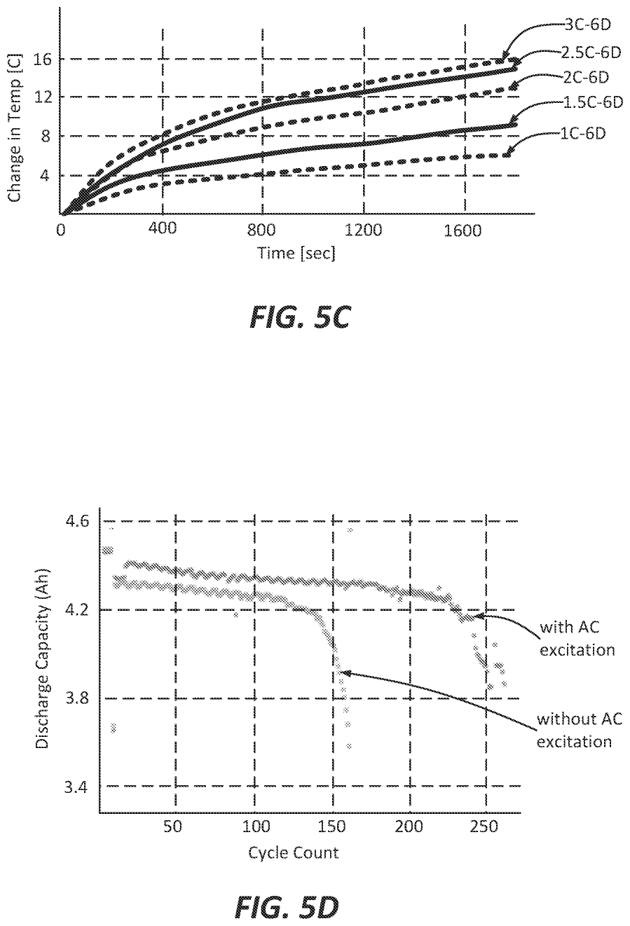

In some examples, the discharge current rate of the set of excitation discharge pulses is higher than the charge current rate of the set of excitation charge pulses. For example, the discharge current rate of the set of excitation discharge pulses is at least 2 times (twice) higher than the charge current rate of the set of excitation charge pulses or, more specifically, at least 2.5 times higher or even three times higher. Using higher discharge rates allows removing/de-plating lithium metal from less desirable locations (e.g., the surface and “hills”). In some examples, the discharge current rate of the set of excitation discharge pulses is at least 5 D or even at least 6 D. In the same or other examples, the charge current rate of the set of excitation charge pulses is at least 1.5 C, at least 2.0 C, or even at least 2.5 C. As further described below with reference to FIG. 5D, lower charge rates do not produce sufficient heating effects. The duration of each excitation charge pulse can be between 0.01 seconds and 2 seconds or, more specifically, between 0.04 seconds and 1 second. While a longer duration may be beneficial from the heating perspective, a significant amount of lithium metal (in undesirable form, e.g., porous) can be deposited if the duration of each excitation charge pulse is extended. The duration of each excitation discharge pulse can be determined based on the desired equivalent charge rate achieved by a combination of each pair of excitation charge and discharge pulses. For example, this desired equivalent charge can be zero as shown in the next table or can be greater than zero (e.g., between 0.1 C and 2 C or, more specifically, between 0.2 C and 1.5 C, or even between 0.5 C and 1 C).

The operation of applying the AC excitation profile can be separate from charging LiMLE electrochemical cell 100 (e.g., the average SOC remains substantially unchanged during this operation) or a part of charging LiMLE electrochemical cell 100 (e.g., the average SOC increases during this operation). For example, the first duration of applying the AC excitation profile is at least three times less than the second duration of charging LiMLE electrochemical cell 100 using the set of charging characteristics. In general, the duration of applying the AC excitation profile should be minimized (e.g., especially when the AC excitation profile does not produce any net changes in the cell SOC) to provide more time for the actual charging operation.

Specifically, in some examples, the AC excitation operation does not impact the average SOC/the average SOC remains substantially unchanged (e.g., changes by less than 5% or even less than 2% on average during this AC excitation operation). In other words, the first state of charge of LiMLE electrochemical cell 100 before applying the AC excitation profile is equal to the second state of charge of LiMLE electrochemical cell 100 after applying the AC excitation profile. In these examples, the rates and durations of the charge and discharge pulses are selected such that the average equivalent rate is substantially zero (e.g., between 0.2 C and 0.2 D or, more specifically, between 0.1 C and 0.1 D). Some examples of these rates and durations are presented in the table below.

TABLE 1
Average Equivalent Charge Rate ~ 0

| Charge Pulse | | Discharge Pulse | |
|---|---|---|---|
| Rate | Duration | Rate | Duration |
| 2.5 C | 1 s | 6 C | 0.417 s |
| 2 C | 2 s | 6.5 C | 0.615 s |
| 1 C | 3 s | 7 C | 0.429 s |
| 1.5 C | 0.5 s | 5 C | 0.150 s |
| 3 C | 0.04 s | 5.5 C | 0.022 s |
| 2.5 C | 0.6 s | 5 C | 0.300 s |

It should be noted that when charge and discharge rates are too small, there is not enough heating provided inside LiMLE electrochemical cell 100 as further described below with reference to FIG. 5C. In some examples, the charge rate during the AC excitation is at least 1.5 C, at least 2.0 C, or even at least 2.5 C. On the other hand, when the charge rate is too high, lithium dendrites and shorts may develop inside LiMLE electrochemical cell 100. In some examples, the charge rate during the AC excitation is at or less than 10 C, at or less than 8 C, or even at or less than 6 C. As noted above, the discharge rate can be much higher than the charge rate, e.g., at least 1.5 times higher or even at least 2 times higher to ensure that lithium is tripped from the surface. Furthermore, longer durations of charge pulses may cause lithium dendrites and shorts, while short pulses may be difficult to implement with practical charging systems. It should be noted that the duration of discharge pulses depends on the relative charge/discharge rate and the duration of charge pulses, e.g., to achieve the equivalent charge rate of about zero.

In other examples, the AC excitation operation causes a net effective change of LiMLE electrochemical cell 100, i.e., the average SOC increases during this AC excitation operation). In other words, the first state of charge of LiMLE electrochemical cell 100 before applying the AC excitation profile is less than the second state of charge of LiMLE electrochemical cell 100 after applying the AC excitation profile. In these examples, the rates and durations of the charge and discharge pulses are selected such that the average equivalent rate is at least about 0.05 C, at least about 0.1 C, at least about 0.2 C, or even at least about 0.5 C. Some examples of these rates and durations are presented in the table below.

TABLE 2
Average Equivalent Charge Rate > 0

| Charge Pulse | | Discharge Pulse | | Net Effective |
|---|---|---|---|---|
| Rate | Duration | Rate | Duration | Change Rate |
| 2.5 C | 1.5 s | 6 C | 0.317 s | 1 C |
| 2.5 C | 0.5 s | 5 C | 0.2 s | 0.36 C |
| 2 C | 2 s | 6 C | 0.1 s | 1.62 C |
| 3 C | 0.5 | 7 C | 0.1 s | 1.33 C |
| 3 C | 2 s | 6 C | 0.2 s | 2.18 C |
| 1.5 C | 0.8 s | 4 C | 0.04 s | 1.24 C |

It should be noted that when the AC excitation operation causes a net effective change of LiMLE electrochemical cell 100, the overall charging time decreases. In other words, the cell heating and cell charging at least partially overlap. In some examples, the cell heating and cell charging fully overlap such that the AC excitation operation effectively use to charge the cell.

Furthermore, the charge and discharge pulses can be selected in such a way that the net effective change of LiMLE electrochemical cell 100 changes (e.g., increases) as the AC excitation operation continues. Referring to Table 2 above, the AC excitation operation can start using charge-discharge pulses that have a low net effective change and then switch to charge-discharge pulses that have a higher net effective change. In some examples, the charge rate-to-discharge rate ratio (C/D ratio) of less than 0.8, less than 0.6, or even less than 0.5 is combined with the maximum average current.

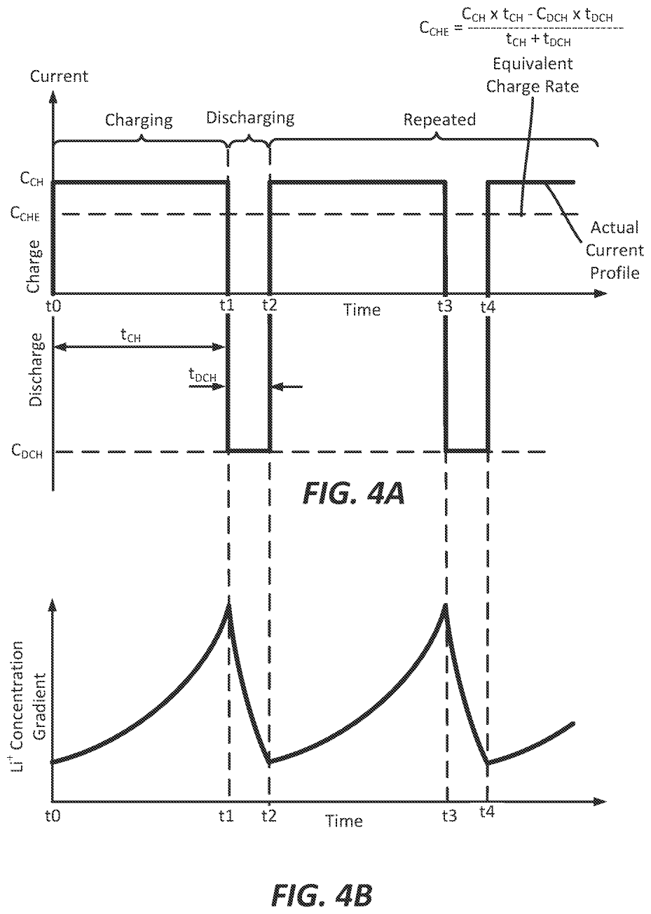

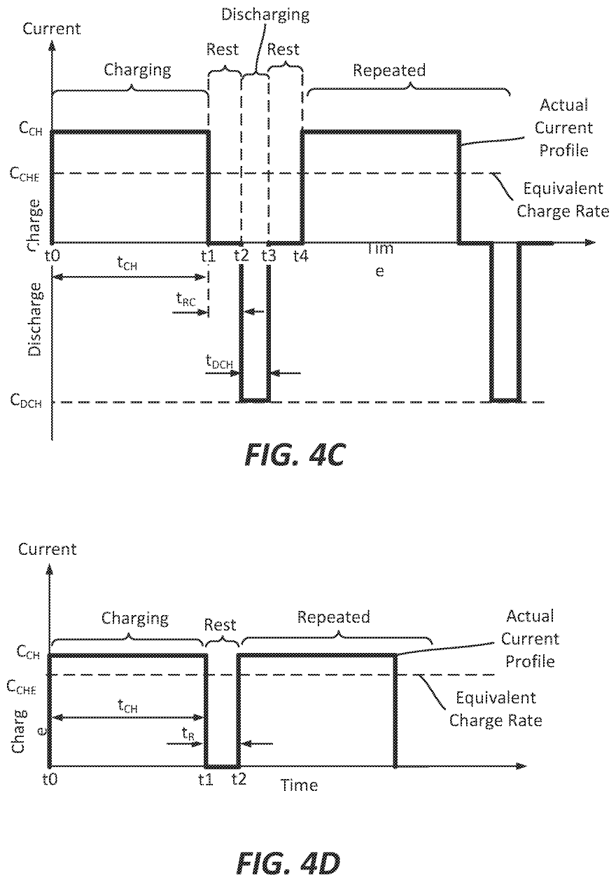

Method 200 proceeds with (block 210) charging LiMLE electrochemical cell 100 using set of charging characteristics 160. In some examples, set of charging characteristics 160 comprises a charging cell temperature that is higher than a discharging cell temperature. In the same or other examples, set of charging characteristics 160 comprises charge pulses such that each pair of charge pulses is separated by a discharge pulse. These examples are further described below with references to FIGS. 3A-3E and FIGS. 4A-4D.

In some examples, method 200 comprises (block 215) cooling LiMLE electrochemical cell 100, e.g., to bring the cell temperature to a discharging cell temperature. In more specific examples, (block 215) cooling comprises (block 217) resting LiMLE electrochemical cell 100 in an environment having an environmental temperature less than the charging cell temperature thereby transferring the heat from LiMLE electrochemical cell 100 to the environment.

Method 200 proceeds with (block 220) discharging LiMLE electrochemical cell 100 using set of discharge characteristics 170.

In some examples, method 200 comprises (block 230) monitoring the temperature of LiMLE electrochemical cell 100. Specifically, (block 210) charging LiMLE electrochemical cell 100 is initiated when LiMLE electrochemical cell 100 reaches the charging cell temperature. In the same or other examples, (block 220) discharging LiMLE electrochemical cell 100 is initiated when LiMLE electrochemical cell 100 reaches the discharging cell temperature. In some examples, the cell temperature obtained during this monitoring operation is used to initiate (block 205) heating operation and/or (block 215) cooling operation

The effect of heating and cooling LiMLE electrochemical cell 100 will now be described with reference to FIGS. 3A-3E. Specifically, FIG. 3A is a plot of charge/discharge rates and corresponding cell temperatures used for cycling LiMLE electrochemical cell 100, in accordance with some examples. Initially (at t₀), the cell temperature can be at a level below the charging cell temperature (T_{CH}). The heating operation is initiated and proceeds until t₁, at which point the cell temperature reaches the charging cell temperature (T_{CH}). The charging can be initiated at this point. While the plot in FIG. 3A illustrates an example in which the heating and charging operations do not overlap, various overlapping examples are within the scope.

The charging cell temperature (T_{CH}) is selected to reduce the electrolyte viscosity and improve the mobility of lithium ions around the negative electrode surface. FIG. 3B is a schematic illustration of lithium-ion distribution within electrolyte while plating lithium on the negative electrode surface of a LiMLE electrochemical cell, in accordance with some examples. Specifically, the negative electrode surface is shown to have a “valley” positioned between two “peaks.” Because lithium ions travel (from the positive electrode) toward this surface and are consumed (plated on the surface) as these ions approach the surface, the concentration of lithium ions is expected to be higher near the peaks than in the valley (a longer path to the bottom of the valley and being consumed along the way). This phenomenon is similar to plating metals in semiconductor vias. As noted above, the concentration gradient is self-aggravating and can cause various issues (e.g., pore formation) in the negative electrode if not mitigated. Heating liquid electrolyte 140 reduces its viscosity and increases lithium-ion mobility within liquid electrolyte 140 as, e.g., is schematically shown in FIG. 3C. The increased lithium-ion mobility helps to mitigate the lithium-ion gradient around the lithium-ion mobility, e.g., with more lithium ions being able to flow into the valleys and be deposited there. In other words, a higher charging cell temperature helps to achieve more uniform lithium plating and mitigate the increase in surface roughness.

However, high temperatures of liquid electrolyte 140 are desirable during the discharge portion of the cycle for similar reasons. A higher temperature and increased lithium-ion mobility reduce the difference in lithium dissolution (de-plating) rates thereby preserving the surface roughness caused during the charge portion of the cycle. When a lower temperature is used during the cell discharge, the peaks are dissolved faster than the bottom of the valleys thereby reducing the surface roughness, which is desirable.

Returning to FIG. 3A, the charging continues until t₂, at which point LiMLE electrochemical cell 100 is cooled down from the charging cell temperature (T_{CH}) to the discharging cell temperature (T_{DCH}). A discharge position of the cycle can proceed at this point, as e.g., is schematically shown by the discharge current (C_{DCH}).

The overall phenomenon of controlling the negative electrode surface roughness using different temperatures for charging and discharging LiMLE electrochemical cell 100 is schematically shown in FIGS. 3D and 3C. Specifically, FIG. 3D are schematic illustrations of lithium metal distribution on the negative-electrode surface during same-temperature cycling, while FIG. 3E are schematic illustrations of lithium metal distribution during high-temperature charging and low-temperature discharging. As noted above, increasing the cell charging temperature helps to reduce the plating rate difference between the peak and valleys thereby reducing the valley depths/surface roughness (ΔCharge2<ΔCharge1). On the other hand, lowering the cell discharging temperature helps to increase the de-plating rate difference between the peak and valleys, which also reduces the valley depths/surface roughness (ΔDischarge2<ΔDischarge1).

FIG. 4A is a plot of longer charging and short discharge pulses while charging LiMLE electrochemical cell 100, in accordance with some examples. It should be noted that these charge and discharge pulses are parts of the overall charging operation, during which the state of charge (SOC) of LiMLE electrochemical cell 100 increases, on average. In other words, on average, LiMLE electrochemical cell 100 continues to charge, which is schematically shown by the equivalent charge rate (C_{CHE}). Short discharge pulses (e.g., between t1 and t2) are used in between charge pulses to ensure periodic redistribution of lithium ions in a portion of liquid electrolyte 140 that is proximate to the negative electrode surface as, e.g., is schematically shown in FIG. 4B. Specifically, a charge pulse is initiated at t0 and proceeds until t1, at which point a discharge pulse is initiated and proceeds until t2. In this example, charging and discharge pulses are not separated by any rest period. The process of switching between charging and discharge pulses continues for the entire charging operation. Referring to FIG. 4B, the lithium-ion concentration gradient increases during each charge pulse. However, the gradient decreases during each discharge pulse. As such, some negative effects of the lithium-ion concentration gradient are mitigated, resulting in an improved cycle life through the delayed electrolyte depletion and through less time being spent by LiMLE electrochemical cell 100 in a constant-voltage charging regimes (associated with a high voltage) thereby protecting the positive electrode.

It is believed that introducing short discharge pulses allows using higher charge rates during the corresponding charged pulses while retaining the cycle life and other characteristics of the battery. The increased charge rates are beneficial to shorten the overall charge time needed (even though the discharge pulses cause this charge time to increase). For example, an experimental result, further discussed below with reference to FIG. 5D, indicates that introducing charge-discharge pulsing with high discharge rates (e.g., 2.5 C for 1 second and 6 D for 0.471 seconds—corresponding to no changes in the SOC) allows raising the charge rate (outside of this pulsing) from 0.7 C to 1 C while maintaining the cycle life of 250 cycles. From the duration perspective, the pulsing can represent 20% of the total time allocated to both pulsing and charging. As such, the equivalent charge rate can be 0.8 C, while still being higher than 0.7 C.

FIGS. 4C and 4D illustrate rest periods in addition to charge pulses while charging LiMLE electrochemical cell 100. Specifically, FIG. 4C illustrates a plot in which any pair of charging and discharge pulses is separated by a rest period. For example, the first charge pulse proceeds between t0 and t1, followed by a rest period between t1 and t2, followed by a discharge pulse between t2 and t3, and finally by another rest period between t3 and t4, before repeating the same sequence of pulses and rest periods. Similar to discharge pulses, rest periods provide some redistribution of lithium ions in liquid electrolyte 140, once the preceding charge pulse stops. In fact, in some examples, rest periods may be used without discharge pulses as, e.g., schematically shown in FIG. 4D. The benefit of this approach is a potential higher equivalent charge rate (C_{CHE}) since the battery cell is not discharged in this profile (without discharge pulses).

In some examples, each charge pulse has a duration (t_{CH}) determined by at least one of the viscosity of liquid electrolyte 140 and the current rate magnitude during each charge pulse (C_{CH}) of LiMLE electrochemical cell 100. Both of these parameters impact the lithium-ion concentration gradient formed during each charge pulse and also the ability to restore this lithium-ion concentration gradient during the discharge pulse.

In some examples, each of the charge pulses has a duration (t_{CH}) of between 0.1 seconds and 60 seconds or, more specifically, between 0.5 seconds and 30 seconds, such as between 1 second and 10 seconds.

In some examples, the current rate magnitude of the discharge pulse (C_{DCH}) is greater than the current rate magnitude of each of the charge pulses (C_{CH}), e.g., at least about 20% greater, at least about 40% greater, at least about 100% greater. This difference allows using relatively short discharge pulses thereby shortening the time of the overall charging operation. It should be noted that charge pulses add energy to LiMLE electrochemical cell 100 while discharge pulses substrate the energy. The overall charge rate can be presented as an equivalent charge rate (C_{CHE}). In other words, the total charge balance is presented by the following equations:

C_{CHE}×(t_{CH}+t_{DCH})=C_{CH}×t_{CH}−C_{DCH}×t_{DCH}

Rearranging this equation for the equivalent charge rate (C_{CHE}) provides:

C_{CHE}=(C_{CH}×t_{CH}−C_{DCH}×t_{DCH})/(t_{CH}+t_{DCH})

In some examples, the equivalent charge rate (C_{CHE}) is at least 1 C or even at least 1.5 C.

Furthermore, this equation cabe rearranged for the discharge pulse has a duration (t_{DCH}):

t_{DCH}=(C_{CH}−C_{CHE})/(C_{DCH}+C_{CHE})×t_{CH}

In the same or other examples, each of the discharge pulses has a duration (t_{DCH}) of between 0.1 seconds and 20 seconds or, more specifically, between 0.5 seconds and 10 seconds, such as between 0.5 seconds and 3 seconds.

### Experimental Data

Various experiments have been conducted to determine the effects of various methods described above on the performance of LiMLE electrochemical cells. Specifically, the tested cell used NMC811 as a positive active material and lithium metal as a negative electrode with an electrolyte having a viscosity of 90 -140 cP at room temperature.

FIG. 5A are relative-charge-capacity plots illustrating three different cycling conditions, i.e., one cell was charged and discharged at 25° C., another cell was charged and discharged at 45° C., and yet another cell was charged at 45° C. and discharged at 25° C. A 1 C charge rate and a 1 D discharge rate were used for all cells. The 45° C. charge/25° C. discharge cell showed the best performance, which is believed to be due to the lowest porosity of lithium on the negative electrode that was maintained during the cycling. This phenomenon is described above with reference to FIGS. 3A-3E. Specifically, increasing the temperature during the charge portion of the cycle by 20° C. almost tripled the corresponding cycle life.

FIG. 5B illustrates discharge capacity plots illustrating two different cycling conditions used on the cells described below (i.e., NMC811 as a positive active material and lithium metal as a negative electrode with an electrolyte having a viscosity of 90 -140 cP at room temperature). One cell was charged with a continuous 1 C rate (and also discharged with a continuous 1 C rate). Another cell was charged with a pulsed profile with an equivalent charge rate of 1 C (and discharged with a continuous 1 C rate). The pulsed profile included 1.27 C charging for 14.03 s and 5.37 D for 0.61 s corresponding to an equivalent charge rate of 1 C. The cell with a pulsed profile has demonstrated significant improvement in cycle life. This phenomenon is described above with reference to FIGS. 4A-4D.

FIG. 5C illustrates temperature profiles of cells subjected to different AC excitation profiles. The profiles used different charge rates (1 C-3 C) lasting 1 second and the same discharge rate of 6 D. The duration of the discharge portion of each pulse was selected to achieve the zero-equivalent rate (i.e., t-discharge=t-charge×Rate-charge/Rate-discharge). The heating effect was significant for rates up to 2.5 C and was diminishing thereafter, which was likely due to the environmental heat losses. As a result of this test, heating at 2.5 C was found to be the most suitable for this cell type. It should be also noted that higher charge rates are less desirable from the overall cycle life perspective even though the charge pulses are separated by discharge pulses with much higher rates.

FIG. 5D illustrates the discharge capacity profiles of two cells cycled at different conditions. One cell was cycled at 0.8 C-1 D without any AC excitation and demonstrated a significant capacity fade after about 150 cycles. The other cell was cycled at 1 C-1 D with a 15-minute AC excitation performed before the charge portion of each cycle. The 15-minute duration of the AC excitation and the 1 C charge rate corresponded to a 0.8 C effective charge rate based on the total time. The AC excitation involved a set of charge-discharge pulses, such that each charge portion of the pulse was performed at 2.5 C for 1 second and each discharge portion of the pulse was performed at 6 C for 0.42 seconds (resulting in no SOC changes after each charge-discharge combined pulse). The capacity fade in the cell with the AC excitation did not occur until after 250 cycles even though a higher charge rate (1 C vs. 0.8 C) was used.

### Clauses

Clause 1. A method (200) for controlling charge and discharge characteristics of a lithium-metal liquid-electrolyte electrochemical cell (100), the method (200) comprising: charging the lithium-metal liquid-electrolyte electrochemical cell (100) using a set of charging characteristics comprising a charging cell temperature, wherein the lithium-metal liquid-electrolyte electrochemical cell (100) comprises a lithium-metal negative electrode (120) and a liquid electrolyte (140) comprising a lithium-containing salt (150) and a liquid solvent (142); and discharging the lithium-metal liquid-electrolyte electrochemical cell (100) using a set of discharge characteristics comprising a discharging cell temperature, wherein: the charging cell temperature is higher than the discharging cell temperature, or the set of charging characteristics comprises charge pulses such that each adjacent pair of the charge pulses is separated by a discharge pulse.

Clause 2. The method (200) of clause 1, wherein the charging cell temperature is higher than the discharging cell temperature by at least 20° C.

Clause 3. The method (200) of any one of clauses 1-2, wherein the charging cell temperature is between 45° C. and 90° C.

Clause 4. The method (200) of any one of clauses 1-3, further comprising prior to charging the lithium-metal liquid-electrolyte electrochemical cell (100), heating the lithium-metal liquid-electrolyte electrochemical cell (100) to the charging cell temperature.

Clause 5. The method (200) of clause 4, wherein heating the lithium-metal liquid-electrolyte electrochemical cell (100) is performed using a heater, thermally coupled to the lithium-metal liquid-electrolyte electrochemical cell (100).

Clause 6. The method (200) of clause 5, wherein the heater is one of: a module heater, thermally coupled to the lithium-metal liquid-electrolyte electrochemical cell (100) by an intercell structure, an intercell heater, directly interfacing the lithium-metal liquid-electrolyte electrochemical cell (100), or an intracell heater, extending within the lithium-metal liquid-electrolyte electrochemical cell (100).

Clause 7. The method (200) of clause 4, wherein heating the lithium-metal liquid-electrolyte electrochemical cell (100) is performed by applying an AC excitation profile to the lithium-metal liquid-electrolyte electrochemical cell (100) comprising a set of excitation charge pulses and a set of excitation discharge pulses, alternating with the set of excitation charge pulses.

Clause 8. The method (200) of clause 7, wherein a discharge current rate of the set of excitation discharge pulses is higher than a charge current rate of the set of excitation charge pulses.

Clause 9. The method (200) of clause 8, wherein the discharge current rate of the set of excitation discharge pulses is at least twice higher than the charge current rate of the set of excitation charge pulses.

Clause 10. The method (200) of clause 8, wherein the discharge current rate of the set of excitation discharge pulses is at least 5 D.

Clause 11. The method (200) of clause 7, wherein a first state of charge of the lithium-metal liquid-electrolyte electrochemical cell (100) before applying the AC excitation profile is equal to a second state of charge of the lithium-metal liquid-electrolyte electrochemical cell (100) after applying the AC excitation profile.

Clause 12. The method (200) of clause 7, wherein a first state of charge of the lithium-metal liquid-electrolyte electrochemical cell (100) before applying the AC excitation profile is less than a second state of charge of the lithium-metal liquid-electrolyte electrochemical cell (100) after applying the AC excitation profile.

Clause 13. The method (200) of clause 7, wherein a first duration of applying the AC excitation profile is at least three times less than a second duration of charging the lithium-metal liquid-electrolyte electrochemical cell (100) using the set of charging characteristics.

Clause 14. The method (200) of any one of clauses 1-13, further comprising, prior to discharging the lithium-metal liquid-electrolyte electrochemical cell (100), cooling the lithium-metal liquid-electrolyte electrochemical cell (100) to the discharging cell temperature.

Clause 15. The method (200) of any one of clauses 1-14, wherein a current rate magnitude of the discharge pulse (CDCH) is greater than a current rate magnitude of each of the charge pulses (CCH).

Clause 16. The method (200) of clause 15, wherein the current rate magnitude of the discharge pulse (CDCH) is at least 20% greater than the current rate magnitude of each of the charge pulses (CCH).

Clause 17. The method (200) of any one of clauses 1-16, wherein the discharge pulse has a duration (t_{DCH}) determined by a formula t_{DCH}=(C_{CH}−C_{CHE})/(C_{DCH}+C_{CHE})×t_{CH}, where CCH is a current rate magnitude during the charge pulses, CDCH is a current rate magnitude during the charge pulses, CCHE is an equivalent charge rate, and tCH is a duration of each of the charge pulses.

Clause 18. The method (200) of clause 17, wherein the equivalent charge rate (CCHE) is at least 1 C.

Clause 19. The method (200) of any one of clauses 1-18, wherein charging the lithium-metal liquid-electrolyte electrochemical cell (100) using the set of charging characteristics is initiated based on at least one of: a discharge capacity of the lithium-metal liquid-electrolyte electrochemical cell (100) in one or more of prior cycles, an overpotential of the lithium-metal liquid-electrolyte electrochemical cell (100) in one or more of the prior cycles, an impedance of the lithium-metal liquid-electrolyte electrochemical cell (100), a direct current internal resistance (DCIR) of the lithium-metal liquid-electrolyte electrochemical cell (100), a duration of a rest period since the prior cycles, an open circuit voltage (OCV) during the rest period since the prior cycles, or one or more operating conditions during the prior cycles.

Clause 20. A battery charging system (190) for controlling charge and discharge characteristics of a lithium-metal liquid-electrolyte electrochemical cell (100) comprising a lithium-metal negative electrode (120) and a liquid electrolyte (140) comprising a lithium-containing salt (150) and a liquid solvent (142), the battery charging system (190) comprising: a power supply (192) configured to flow an electric current through the lithium-metal liquid-electrolyte electrochemical cell (100) in accordance with a set of charging characteristics while charging the lithium-metal liquid-electrolyte electrochemical cell (100) and in accordance with a set of discharge characteristics while discharging the lithium-metal liquid-electrolyte electrochemical cell (100); and a controller (194), communicatively coupled to the power supply (192) and comprising a memory (196) storing the set of charging characteristics and the set of discharge characteristics, wherein at least one: the set of charging characteristics comprises a charging cell temperature that is higher than a discharging cell temperature of the set of discharge characteristics, or the set of charging characteristics comprises charge pulses such that each pair of the charge pulses is separated by a discharge pulse.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered illustrative and not restrictive.

1. A method for controlling charge and discharge characteristics of a lithium-metal liquid-electrolyte electrochemical cell, the method comprising:
charging the lithium-metal liquid-electrolyte electrochemical cell using a set of charging characteristics comprising a charging cell temperature, wherein the lithium-metal liquid-electrolyte electrochemical cell comprises a lithium-metal negative electrode and a liquid electrolyte comprising a lithium-containing salt and a liquid solvent; and
discharging the lithium-metal liquid-electrolyte electrochemical cell using a set of discharge characteristics comprising a discharging cell temperature, wherein:
the charging cell temperature is higher than the discharging cell temperature, or
the set of charging characteristics comprises charge pulses such that each adjacent pair of the charge pulses is separated by a discharge pulse.

2. The method of claim 1, wherein the charging cell temperature is higher than the discharging cell temperature by at least 20° C.

3. The method of claim 1, wherein the charging cell temperature is between 45° C. and 90° C.

4. The method of claim 1, further comprising prior to charging the lithium-metal liquid-electrolyte electrochemical cell, heating the lithium-metal liquid-electrolyte electrochemical cell to the charging cell temperature.

5. The method of claim 4, wherein heating the lithium-metal liquid-electrolyte electrochemical cell is performed using a heater, thermally coupled to the lithium-metal liquid-electrolyte electrochemical cell.

6. The method of claim 5, wherein the heater is one of:
a module heater, thermally coupled to the lithium-metal liquid-electrolyte electrochemical cell by an intercell structure,
an intercell heater, directly interfacing the lithium-metal liquid-electrolyte electrochemical cell, or
an intracell heater, extending within the lithium-metal liquid-electrolyte electrochemical cell.

7. The method of claim 4, wherein heating the lithium-metal liquid-electrolyte electrochemical cell is performed by applying an AC excitation profile to the lithium-metal liquid-electrolyte electrochemical cell comprising a set of excitation charge pulses and a set of excitation discharge pulses, alternating with the set of excitation charge pulses.

8. The method of claim 7, wherein a discharge current rate of the set of excitation discharge pulses is higher than a charge current rate of the set of excitation charge pulses.

9. The method of claim 8, wherein the discharge current rate of the set of excitation discharge pulses is at least twice higher than the charge current rate of the set of excitation charge pulses.

10. The method of claim 8, wherein the discharge current rate of the set of excitation discharge pulses is at least 5 D.

11. The method of claim 7, wherein a first state of charge of the lithium-metal liquid-electrolyte electrochemical cell before applying the AC excitation profile is equal to a second state of charge of the lithium-metal liquid-electrolyte electrochemical cell after applying the AC excitation profile.

12. The method of claim 7, wherein a first state of charge of the lithium-metal liquid-electrolyte electrochemical cell before applying the AC excitation profile is less than a second state of charge of the lithium-metal liquid-electrolyte electrochemical cell after applying the AC excitation profile.

13. The method of claim 7, wherein a first duration of applying the AC excitation profile is at least three times less than a second duration of charging the lithium-metal liquid-electrolyte electrochemical cell using the set of charging characteristics.

14. The method of claim 1, further comprising, prior to discharging the lithium-metal liquid-electrolyte electrochemical cell, cooling the lithium-metal liquid-electrolyte electrochemical cell to the discharging cell temperature.

15. The method of claim 1, wherein a current rate magnitude of the discharge pulse (C_{DCH}) is greater than a current rate magnitude of each of the charge pulses (C_{CH}).

16. The method of claim 15, wherein the current rate magnitude of the discharge pulse (C_{DCH}) is at least 20% greater than the current rate magnitude of each of the charge pulses (C_{CH}).

17. The method of claim 1, wherein the discharge pulse has a duration (t_{DCH}) determined by a formula t_{DCH}=(C_{CH}−C_{CHE})/(C_{DCH}+C_{CHE})×t_{CH}, where
C_{CH} is a current rate magnitude during the charge pulses,
C_{DCH} is a current rate magnitude during the charge pulses,
C_{CHE} is an equivalent charge rate, and
t_{CH} is a duration of each of the charge pulses.

18. The method of claim 17, wherein the equivalent charge rate (C_{CHE}) is at least 1 C.

19. The method of claim 1, wherein charging the lithium-metal liquid-electrolyte electrochemical cell using the set of charging characteristics is initiated based on at least one of:
a discharge capacity of the lithium-metal liquid-electrolyte electrochemical cell in one or more of prior cycles,
an overpotential of the lithium-metal liquid-electrolyte electrochemical cell in one or more of the prior cycles,
an impedance of the lithium-metal liquid-electrolyte electrochemical cell,
a direct current internal resistance (DCIR) of the lithium-metal liquid-electrolyte electrochemical cell,
a duration of a rest period since the prior cycles,
an open circuit voltage (OCV) during the rest period since the prior cycles, or
one or more operating conditions during the prior cycles.

20. A battery charging system for controlling charge and discharge characteristics of a lithium-metal liquid-electrolyte electrochemical cell comprising a lithium-metal negative electrode and a liquid electrolyte comprising a lithium-containing salt and a liquid solvent, the battery charging system comprising:
a power supply configured to flow an electric current through the lithium-metal liquid-electrolyte electrochemical cell in accordance with a set of charging characteristics while charging the lithium-metal liquid-electrolyte electrochemical cell and in accordance with a set of discharge characteristics while discharging the lithium-metal liquid-electrolyte electrochemical cell; and
a controller, communicatively coupled to the power supply and comprising a memory storing the set of charging characteristics and the set of discharge characteristics, wherein:
the set of charging characteristics comprises a charging cell temperature that is higher than a discharging cell temperature of the set of discharge characteristics, or
the set of charging characteristics comprises charge pulses such that each pair of the charge pulses is separated by a discharge pulse.
